(19) United States
(12) Patent Application Publication
(10) Pub. No.: US 2025/0012143 A1
(43) Pub. Date: Jan. 9, 2025

(54) WINDOW SHADE AND ACTUATING SYSTEM THEREOF

(71) Applicant: Teh Yor Co., Ltd., New Taipei City (TW)

(72) Inventors: Chin-Tien HUANG, New Taipei City (TW); Wen-Chin WU, New Taipei City (TW)

(73) Assignee: Teh Yor Co., Ltd., New Taipei City (TW)

(21) Appl. No.: 18/763,132

(22) Filed: Jul. 3, 2024

Related U.S. Application Data
(60) Provisional application No. 63/525,530, filed on Jul. 7, 2023.

(51) Int. Cl. E06B 9/322; E06B 9/262

(52) U.S. Cl. CPC E06B 9/322; E06B 9/262; E06B 2009/2627; E06B 2009/3225

(57) ABSTRACT

An actuating system for a window shade includes a transmission axle rotatable about a longitudinal axis thereof, and a speed stabilizer including a housing having an inner wall, and a rotary plate disposed inside the housing and configured to rotationally couple to the transmission axle, the rotary plate carrying a plurality of friction elements angularly spaced apart from one another about the longitudinal axis of the transmission axis, the rotary plate being rotatable along with the transmission axle with the friction elements rubbing against the inner wall of the housing.

### CROSS-REFERENCE TO RELATED APPLICATION(S)

This application claims priority to U.S. provisional patent application No. 63/525,530 filed on Jul. 7, 2023, the disclosure of which is incorporated herein by reference.

### BACKGROUND

### 1. Field of the Invention

The present invention relates to window shades, in particular to actuating systems for window shades.

### 2. Description of the Related Art

Some window shades may use an operating cord for raising a bottom part of the window shade and a wand for lowering the bottom part. More specifically, the operating cord may be pulled to drive a rotary part in rotation, which can be transmitted to a transmission axle so that the transmission axle can rotate for winding a suspension cord connected to the bottom part. When a user rotates the wand, an arrester coupled to the wand can release the transmission axle, which can rotate freely as the bottom part lowers under gravity action. This free fall of the bottom part may accidentally hit a user, and damage components of the window shade.

### SUMMARY

The present application describes an actuating system for a window shade that can address at least some of the aforementioned issues.

According to one aspect, the actuating system includes a transmission axle rotatable about a longitudinal axis thereof, and a speed stabilizer including a housing having an inner wall and a rotary plate disposed inside the housing and configured to rotationally couple to the transmission axle, the rotary plate carrying a plurality of friction elements angularly spaced apart from one another about the longitudinal axis of the transmission axis, the rotary plate being rotatable along with the transmission axle with the friction elements rubbing against the inner wall of the housing.

According to another aspect, the present application provides a window shade including the aforementioned actuating system.

### BRIEF DESCRIPTION OF THE DRAWINGS

FIGS. 1 and 2 are perspective views illustrating an embodiment of a window shade in different states;

FIG. 3 is an exploded view of the window shade shown in FIG. 1;

FIG. 4 is an exploded view of a speed stabilizer provided in an actuating system for a window shade;

FIG. 5 is an exploded view illustrating the speed stabilizer of FIG. 4 from another angle of view;

FIGS. 6 and 7 are cross-sectional views illustrating exemplary operation of the speed stabilizer shown in FIG. 4; and

FIG. 8 is an exploded view illustrating a variant embodiment of the speed stabilizer.

### DETAILED DESCRIPTION OF THE EMBODIMENTS

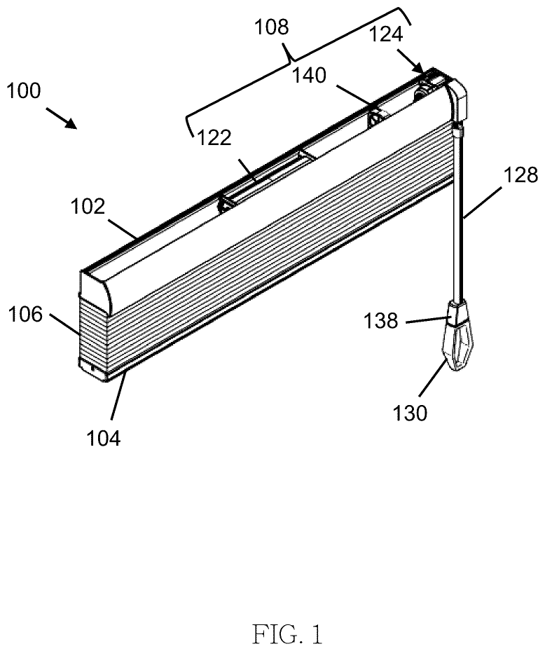

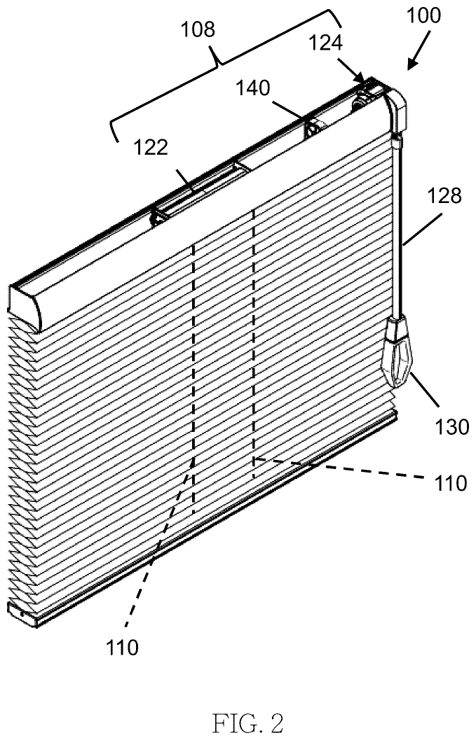

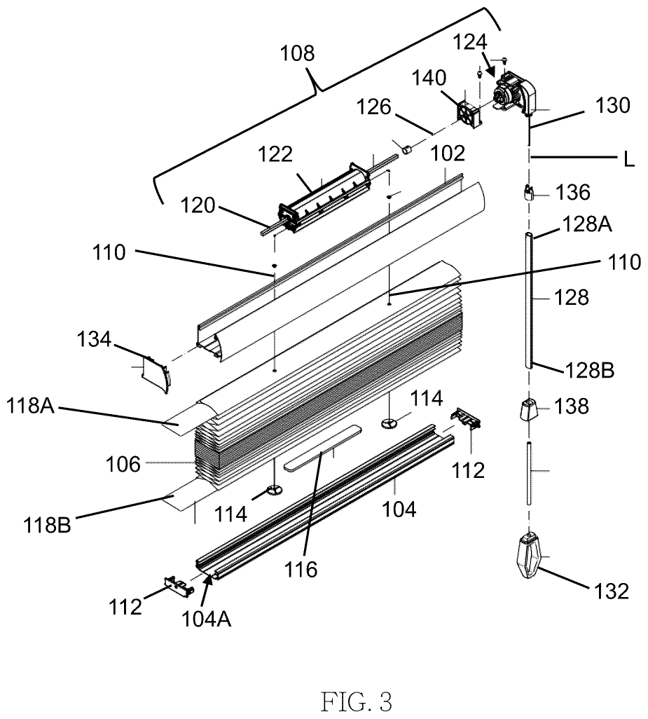

FIGS. 1 and 2 are perspective views illustrating an embodiment of a window shade 100 in different states, and FIG. 3 is an exploded view of the window shade 100. Referring to FIGS. 1-3, the window shade 100 can include a head rail 102, a movable rail 104, a shading structure 106 and an actuating system 108. The window shade 100 is shown in a retracted or raised state in FIG. 1, and in an expanded or lowered state in FIG. 2.

The head rail 102 may be affixed at a top of a window frame, and can have any desirable shapes. According to an example of construction, the head rail 102 can have an elongate shape including a cavity for at least partially receiving the actuating system 108 of the window shade 100.

The movable rail 104 can be suspended from the head rail 102 with a plurality of suspension elements 110 (shown with phantom lines in FIG. 2). According to an example of construction, the movable rail 104 may be an elongate rail having a channel 104A adapted to receive to the attachment of the shading structure 106. The channel 104A of the movable rail 104 may be closed at two opposite ends with two end caps 112. Examples of the suspension elements 110 may include, without limitation, cords, strips, bands, and the like. The suspension elements 110 may be respectively connected to the movable rail 104 via fasteners 114. According to an example, the movable rail 104 may be a bottom rail of the window shade 100. A weighing element 116 may be disposed inside the channel 104A to add stability to the movable rail 104 during use.

The shading structure 106 may have any suitable structure that can be expanded and collapsed between the head rail 102 and the movable rail 104. According to an example of construction, the shading structure 106 can have a cellular structure, which may include, without limitation, honeycomb structures. In one embodiment where the shading structure 106 has a cellular structure, two stiffened strips 118A and 118B may be respectively attached to an upper end and a lower end of the cellular structure for facilitating its assembly with the head rail 102 and the movable rail 104. During use, the shading structure 106 and the movable rail 104 can be suspended from the head rail 102, and the shading structure 106 can be expanded or collapsed by displacing the movable rail 104 away from or toward the head rail 102.

Referring to FIGS. 1-3, the movable rail 104 can move vertically relative to the head rail 102 for setting the window shade 100 to a desirable configuration. For example, the movable rail 104 may be raised toward the head rail 102 to collapse the shading structure 106 as shown in FIG. 1, or lowered away from the head rail 102 to expand the shading structure 106 as shown in FIG. 2. The vertical position of the movable rail 104 relative to the head rail 102 may be controlled with the actuating system 108.

Referring to FIGS. 1-3, the actuating system 108 is mounted to the head rail 102, and is operable to displace the movable rail 104 relative to the head rail 102 for expanding and collapsing the shading structure 106. The actuating system 108 can include a transmission axle 120, at least one winding unit 122 rotationally coupled to the transmission axle 120, and a control module 124 connected to the transmission axle 120.

The transmission axle 120 and the winding unit 122 can be assembled with the head rail 102. The transmission axle 120 is coupled to the winding unit 122, and can rotate about a longitudinal axis 126 of the transmission axle 120. The winding unit 122 is connected to the movable rail 104 via one or more of the suspension elements 110, and is operable to wind the suspension elements 110 for raising the movable rail 104 and to unwind the suspension elements 110 for lowering the movable rail 104. For example, the winding unit 122 may include a rotary drum (not shown) that is rotationally coupled to the transmission axle 120 and is connected to one end of each of two suspension elements 110, and the other end of each of the two suspension elements 110 can be connected to the movable rail 104, whereby the rotary drum can rotate along with the transmission axle 120 to wind or unwind the suspension elements 110.

The control module 124 is connected to an end of the transmission axle 120, and is operable to cause the transmission axle 120 to rotate in either direction about the longitudinal axis 126 for expanding or collapsing the shading structure 106.

According to an embodiment, the control module 124 can include a wand 128, and an operating element 130 and a handle 132 coupled to each other. The wand 128 and the handle 132 are operable independently of each other for adjusting the shading structure 106. For example, one of the wand 128 and the handle 132 is operable to expand the shading structure 106 by lowering the movable rail 104, and the other one of the wand 128 and the handle 132 is operable to collapse the shading structure 106 by raising the movable rail 104. The control module 124 may be mounted to the head rail 102 at one end thereof, and the other end of the head rail 102 may be closed with an end cap 134.

The wand 128 has an elongate shape and a hollow interior, which can extend along a lengthwise axis L of the wand 128 between two opposite ends 128A and 128B thereof. Examples of materials for making the wand 128 may include, without limitation, plastic materials. The end 128A of the wand 128 can be pivotally connected to the head rail 102 via an articulation 136. The articulation 136 can be configured to allow rotation of the wand 128 about the lengthwise axis L and tilting of the wand 128 to different inclination relative to the head rail 102. The wand 128 is rotatable about the lengthwise axis L for actuating the control module 124.

The operating element 130 can include any flexible linear components. Examples for making the operating element 130 can include, without limitation, cords, strips, cables and the like. The operating element 130 extends outside the wand 128 at the end 128A, and can have an end connected to a rotary drum (not shown) of the control module 124, wherein the rotary drum is rotatable for winding and unwinding the operating element 130. Moreover, the operating element 130 can be threaded through the articulation 136 and the end 128A of the wand 128, and can extend along the lengthwise axis L inside the hollow interior of the wand 128.

The handle 132 is disposed at the end 128B of the wand 128, and is coupled to the operating element 130. The handle 132 can have any suitable shapes that can be manually grasped by a user for operation. The handle 132 is operable to actuate the control module 124 by pulling on the operating element 130 so that the rotary drum (not shown) inside the control module 124 is urged in rotation in the unwinding direction. More specifically, the handle 132 is movable relative to the wand 128 between a first position where the handle 132 is located adjacent to the end 128B of the wand 128, and a second position where the handle 132 is displaced away from the end 128B of the wand 128. The handle 132 can be pulled away from the end 128B of the wand 128 to actuate the control module 124 for adjusting the shading structure 106.

Referring to FIGS. 1-3, the wand 128 can have a sleeve 138 fixedly connected thereto at the end 128B, the sleeve 138 having a cross-section that is larger than a cross-section of the wand 128. The handle 132 can lie adjacent to and can be at least partially received in the sleeve 138 in the first position. The sleeve 138 can facilitate positioning of the handle 132 in the first position.

According to an embodiment, the control module 124 can be configured so that the handle 132 is operable to pull the operating element 130 for collapsing the shading structure 106, and the wand 128 is rotatable about the lengthwise axis L thereof for expanding the shading structure 106. For example, the movable rail 104 can be lowered for expanding the shading structure 106 by rotating the wand 128 about the lengthwise axis L in a first direction. This angular displacement of the wand 128 can be made while the handle 132 remains in the first position adjacent to the end 128B of the wand 128. Once the movable rail 104 reaches a desirable lowered position, the wand 128 can be rotated about the lengthwise axis L in a second direction opposite to the first direction to recover its initial position, which stops the movable rail 104 at the desirable position.

The movable rail 104 can be raised a distance by displacing the handle 132 away from the end 128B of the wand 128. While the movable rail 104 moves upward, the user can release the handle 132 at any time, e.g., when the movable rail 104 has reached a desired height or the operating element 130 has been entirely unwound from the rotary drum inside the control module 124. When the handle 132 is released, the rotary drum inside the control module 124 can rotate in a reverse direction that winds at least partially the operating element 130, which causes the handle 132 to move to its first position adjacent to the end 128B of the wand 128. While the handle 132 moves toward the end 128B of the wand 128, the movable rail 104 remains in position relative to the head rail 102. The aforementioned sequence of pulling and releasing the handle 132 can be repeated multiple times until the shading structure 106 is totally collapsed.

The control module 124 can have any suitable constructions for implementing the aforementioned operations. For example, the control module 124 may include one or more clutching elements (not shown) coupled to the rotary drum inside the control module 124, and one or more braking springs (not shown) coupled to the wand 128. A rotation of the rotary drum inside the control module 124 for unwinding the operating element 130 can cause the one or more clutching elements to couple the rotary drum to the transmission axle 120 so that the transmission axle 120 rotates along with the rotary drum for raising the movable rail 104, and a rotation of the rotary drum for winding the operating element 130 can cause the one or more clutching elements to decouple the rotary drum from the transmission axle 120 so that the transmission axle 120 is locked by the one or more braking springs for holding the movable rail 104 in position. An angular displacement of the wand 128 about its lengthwise axis L can urge the one or more braking springs to release the transmission axle 120, which then can rotate for lowering the movable rail 104 by gravity action. Various constructions of control modules are known in the prior art to include the aforementioned clutching elements and braking springs, which are not illustrated herein for the sake of clarity.

Referring to FIGS. 1-3, the actuating system 108 further includes a speed stabilizer 140 connected to the transmission axle 120. The speed stabilizer 140 is adapted to reduce and stabilize a rotational speed of the transmission axle 120. According to an example of assembly, the speed stabilizer 140 may be provided as a separate module disposed apart from the control module 124 along the transmission axle 120. This may facilitate installation and removal of the speed stabilizer 140 as desired.

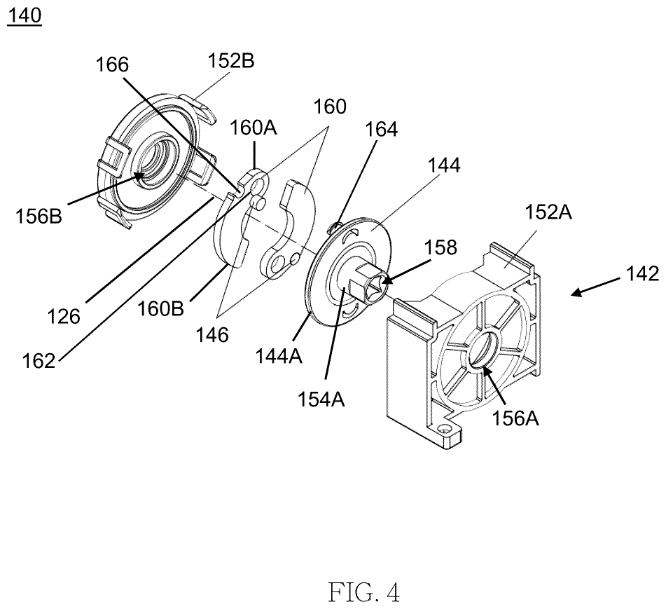

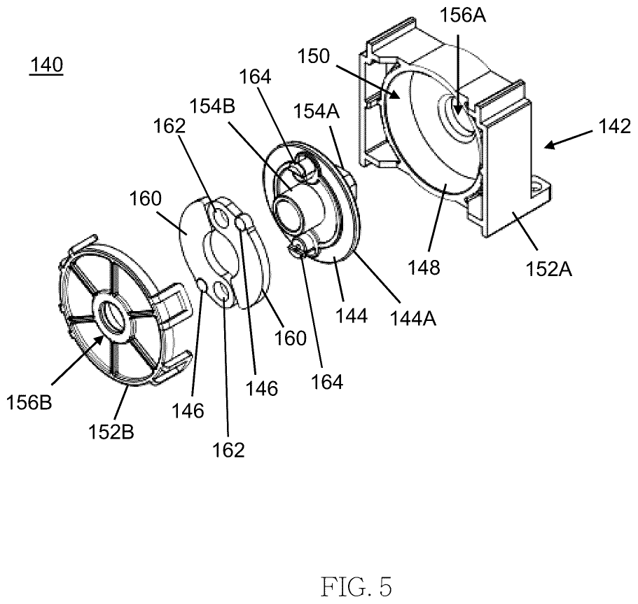

In conjunction with FIG. 3, FIGS. 4 and 5 are exploded views illustrating the speed stabilizer 140. Referring to FIGS. 3-5, the speed stabilizer 140 includes a housing 142, and a rotary plate 144 carrying a plurality of friction elements 146.

The housing 142 has an inner wall 148 that at least partially defines an inner cavity 150 in which the rotary plate 144 and the friction elements 146 are disposed. According to an example of construction, the housing 142 can include a casing 152A and a lid 152B fastened to each other to at least partially delimit the inner cavity 150 in which the rotary plate 144 and the friction elements 146 are disposed, and the inner wall 148 may be provided in the casing 152A. The transmission axle 120 can be disposed so as to extend through the casing 152A and the lid 152B.

Referring to FIGS. 3-5, the rotary plate 144 is disposed inside the housing 142, and is configured to rotationally couple to the transmission axle 120 so that the transmission axle 120 and the rotary plate 144 are rotatable in unison relative to the housing 142. According to an example of construction, the rotary plate 144 can be pivotally connected to the housing 142. For example, the rotary plate 144 can have a disk shape having two shaft portions 154A and 154B that respectively protrude at two opposite sides along the longitudinal axis 126, and the casing 152A and the lid 152B can respectively have two openings 156A and 156B through which the two shaft portions 154A and 154B are pivotally connected to the housing 142. The rotary plate 144 can further have a hole 158 extending through the two shaft portions 154A and 154B, and the transmission axle 120 can fitted through the hole 158. The transmission axle 120 and the hole 158 can have mutually matching shapes to rotationally couple the rotary plate 144 to the transmission axle 120.

The friction elements 146 carried with the rotary plate 144 are disposed angularly spaced apart from one another about the longitudinal axis 126 of the transmission axis 120, and are movable along with the rotary plate 144 as the transmission axle 120 and the rotary plate 144 rotate in unison about the longitudinal axis 126. The placement of the friction elements 146 on the rotary plate 144 is such that the rotary plate 144 is rotatable along with the transmission axle 120 relative to the housing 142 with the friction elements 146 rubbing against the inner wall 148 of the housing 142.

Each of the friction elements 146 is formed integrally as a single body, and may have any suitable shapes. According to an example of construction, each of the friction elements 146 can be at least partially cylindrical in shape. According to another example of construction, each of the friction elements 146 may be at least partially spherical in shape. Examples of suitable materials for making the friction elements 146 can include, without limitation, oil resistant rubber, fluorocarbon rubber and silicone rubber.

The rubbing action between the friction elements 146 and the inner wall 148 of the housing 142 generates friction that tends to reduce and assist in stabilizing the rotational speed of the transmission axle 120. According to an embodiment, the friction elements 146 may be in lubricated contact against the inner wall 148 of the housing 142. Any suitable lubricants may be applied. The lubricated contact may reduce noise and wear.

Referring to FIGS. 4 and 5, the friction elements 146 can be fixedly connected to a plurality of supporting arms 160 that are coupled to the rotary plate 144. Each supporting arm 160 and the friction element 146 fixedly connected thereto can be configured to be movable freely relative to the rotary plate 144. According to an example of construction, the supporting arms 160 may be movably connected to the rotary plate 144, and can be biased to displace the friction elements 146 toward the inner wall 148 of the housing 142 as the transmission axle 120 and the rotary plate 144 rotate in unison about the longitudinal axis 126. Examples of movable connections between the rotary plate 144 and the supporting arms 160 may include, without limitation, pivotal connections and/or sliding connections. The connection between the rotary plate 144 and the supporting arms 160 allows the supporting arms 160 to freely move relative to the rotary plate 144.

Each of the supporting arms 160 can be configured to freely move as a single body relative to the rotary plate 144. According to an example of construction, each of the supporting arms 160 has a coupling end 160A and a distal end 160B, and can be pivotally connected to the rotary plate 144 at the coupling end 160A. For example, the coupling end 160A of the supporting arm 160 can have a hole 162, and the rotary plate 144 can have a pivot pin 164 that is disposed through the hole 162, whereby the supporting arm 160 can rotate about the pivot pin 164 relative to the rotary plate 144. Each of the supporting arms 160 can be pivotally connected to the rotary plate 144 in a similar manner.

Each of the supporting arms 160 can hold at least one friction element 146. For example, the supporting arm 160 can have an outer edge provided with a notch 166, and the friction element 146 can be partially received in and fixedly attached to the notch 166. The friction element 146 may be placed at any suitable positions on the supporting arm 160. According to an example of construction, one or more friction element 146 may be fixedly connected to the supporting arm 160 at a location that is closer to the coupling end 160A thereof than the distal end 160B thereof. As the supporting arm 160 moves relative to the rotary plate 144, the friction element 146 coupled thereto can be urged to move and protrude outward from an outer edge 144A of the rotary plate 144.

In the illustrated embodiment, two supporting arms 160 are provided to respectively hold two friction elements 146. Each supporting arm 160 can have an arcuate shape, and the two supporting arms 160 can be disposed to substantially surround the shaft portion 154B of the rotary plate 144. The two supporting arms 160 can be respectively connected pivotally to the rotary plate 144 at two locations away from the longitudinal axis 126, e.g., about two pivot pins 164 at two diametrically opposite locations. Each of the two supporting arms 160 can be pivotally connected to the rotary plate 144 at the coupling end 160A thereof, the coupling end 160A of one of the two supporting arms 160 being adjacent to the distal end 160B of the other one of the two supporting arms 160.

Although the illustrated embodiment provides two friction elements 146 respectively paired to two supporting arms 160, it will be appreciated that any suitable numbers of the friction elements 146 and the supporting arms 160 may be provided on the rotary plate 144. For example, the rotary plate 144 may be provided with one, two, three or four friction elements 146/supporting arms 160. Moreover, the number of the friction elements 146 coupled to each supporting arm 160 may be varied. For example, one supporting arm 160 may be coupled to one, two or three friction elements 146.

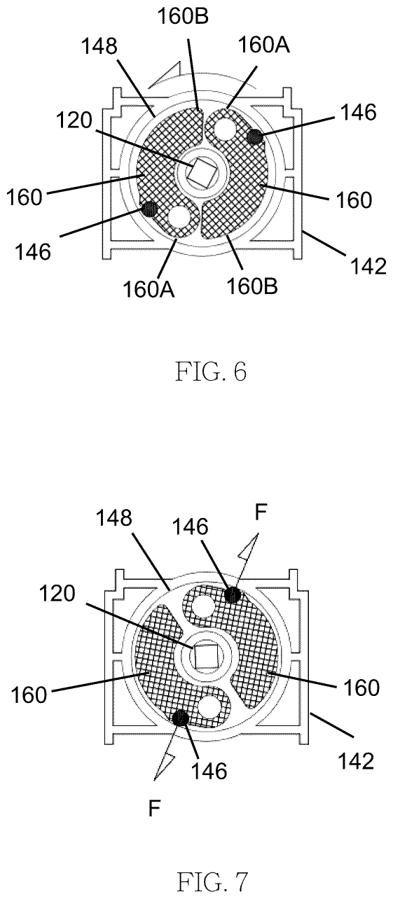

In conjunction with FIGS. 3-5, FIGS. 6 and 7 are cross-sectional views illustrating exemplary operation of the speed stabilizer 140. As the transmission axle 120 and the rotary plate 144 rotate in unison about the longitudinal axis 126 relative to the housing 142, the supporting arms 160 can be biased by centrifugal forces F to press the friction elements 146 against the inner wall 148 of the housing 142. When the movable rail 104 is lowered by gravity action, the speed stabilizer 140 can thus generate friction that tends to reduce the rotational speed of the transmission axle 120, which can result in a smooth displacement of the movable rail 104.

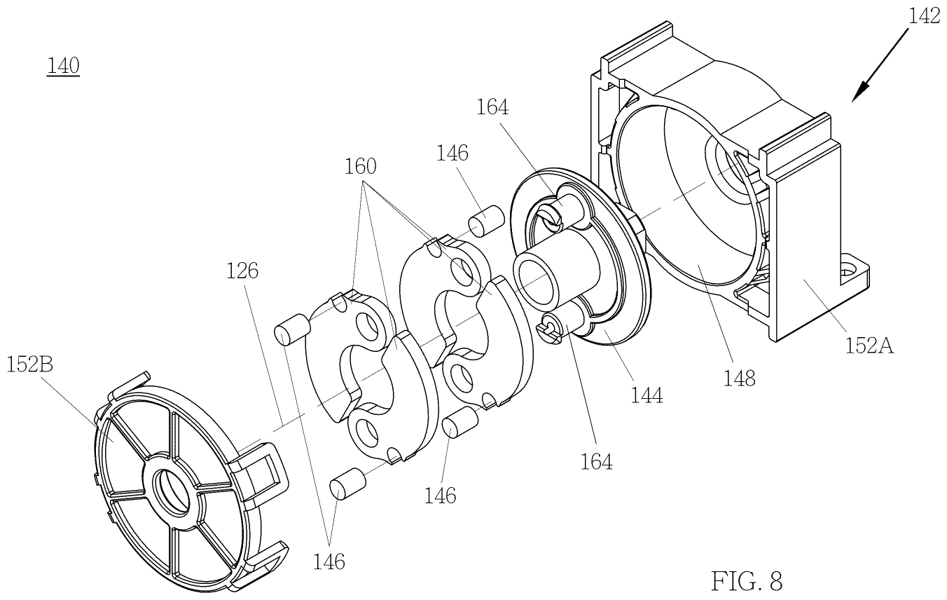

Although the embodiment of FIGS. 4 and 5 provides two supporting arms 160, the number of supporting arms 160 may be varied according to the needs. FIG. 8 is an exploded view illustrating a variant embodiment of the speed stabilizer 140 including four supporting arms 160. Referring to FIG. 8, the rotary plate 144 may be provided with two pivot pins 164 for assembling the 4 supporting arms 160. Like in the previous embodiment, the two pivot pins 164 may be disposed on the rotary plate 144 at two diametrically opposite locations relative to the longitudinal axis 126. Each pivot pin 164 in the embodiment of FIG. 8 may have an axial length that is greater than the axial length of the pivot pin 164 of the previous embodiment, and may be pivotally connected to two ones of the 4 supporting arms 160. Two ones of the 4 supporting arms 160 are thus disposed adjacent to each other and are rotatable about one same pivot pin 164 relative to the rotary plate 144, and the other two ones of the 4 supporting arms 160 are disposed adjacent to each other and are rotatable about the other pivot pin 164 relative to the rotary plate 144. It will be appreciated that more than two supporting arms 160 may be pivotally connected about a same pivot pin 164 in case the number of provided supporting arms 160 is increased. Like in the previous embodiment, each supporting arm 160 may hold at least one friction element 146. As the rotary plate 144 rotate about the longitudinal axis 126 relative to the housing 142, the supporting arms 160 can be likewise biased by centrifugal forces to press the friction elements 146 against the inner wall 148 of the housing 142.

Advantages of the structures described herein include the ability to provide a speed stabilizer that is simple in construction and can be easily incorporated in an actuating system to assist in providing a smooth adjustment of the window shade.

Realization of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. An actuating system for a window shade, comprising:
a transmission axle rotatable about a longitudinal axis thereof; and
a speed stabilizer including:
a housing having an inner wall; and
a rotary plate disposed inside the housing and configured to rotationally couple to the transmission axle, the rotary plate carrying a plurality of friction elements angularly spaced apart from one another about the longitudinal axis of the transmission axle, the rotary plate being rotatable along with the transmission axle with the friction elements rubbing against the inner wall of the housing.

2. The actuating system according to claim 1, wherein the friction elements are in lubricated contact against the inner wall of the housing.

3. The actuating system according to claim 1, wherein the friction elements are connected fixedly to a plurality of supporting arms that are coupled to the rotary plate, the supporting arms being biased to displace the friction elements toward the inner wall of the housing as the transmission axle and the rotary plate rotate in unison about the longitudinal axis.

4. The actuating system according to claim 3, wherein the supporting arms are biased by centrifugal forces to press the friction elements against the inner wall of the housing as the transmission axle and the rotary plate rotate in unison about the longitudinal axis.

5. The actuating system according to claim 3, wherein each of the supporting arms is pivotally connected to the rotary plate.

6. The actuating system according to claim 5, wherein the rotary plate has a pivot pin, and multiple ones of the supporting arms are pivotally connected about the pivot pin.

7. The actuating system according to claim 5, wherein the supporting arms include two supporting arms that are respectively connected pivotally to the rotary plate at two locations away from the longitudinal axis.

8. The actuating system according to claim 7, wherein the two supporting arms are respectively connected pivotally to the rotary plate at two diametrically opposite locations.

9. The actuating system according to claim 7, wherein each of the two supporting arms has a coupling end and a distal end, each of the two supporting arms being pivotally connected to the rotary plate at the coupling end thereof, the coupling end of one of the two supporting arms being disposed adjacent to the distal end of the other one of the two supporting arms.

10. The actuating system according to claim 9, wherein each of the two supporting arms holds at least one of the friction elements at a location that is closer to the coupling end thereof than the distal end thereof.

11. The actuating system according to claim 1, wherein each of the friction elements is at least partially cylindrical in shape.

12. The actuating system according to claim 1, wherein the friction elements are made of a material including oil resistant rubber, fluorocarbon rubber and silicone rubber.

13. The actuating system according to claim 1, wherein the housing includes a casing and a lid fastened to each other to at least partially delimit an inner cavity in which the rotary plate and the friction elements are disposed, the transmission axle extending through the casing and the lid.

14. The actuating system according to claim 1, further including a control module connected to the transmission axle, the control module being operable to cause the transmission axle to rotate for expanding or collapsing a shading structure, the speed stabilizer being disposed apart from the control module along the transmission axle.

15. A window shade comprising:
a head rail;
a shading structure suspended from the head rail; and
the actuating system according to claim 1, being mounted to the head rail, the actuating system being operable to expand and collapse the shading structure.
